(19) United States
(12) Patent Application Publication
(10) Pub. No.: US 2014/0307487 A1
(43) Pub. Date: Oct. 16, 2014

(54) Full Bridge Oscillation Resonance High Power Factor Invertor

(71) Applicants: Yong-Nong Chang, Huwei Township (TW); Deng-Chiun Huang, Huwei Township (TW)

(72) Inventors: Yong-Nong Chang, Huwei Township (TW); Deng-Chiun Huang, Huwei Township (TW)

(21) Appl. No.: 13/859,781

(22) Filed: Apr. 10, 2013

(51) Int. Cl. H02M 7/5387; H02M 5/458

(52) U.S. Cl. CPC H02M 7/53871; H02M 5/458
USPC 363/34; 363/98

(57) ABSTRACT

A full bridge oscillation resonance high power factor invertor being connected between a power source and a Load has a first inductor and a second inductor. The first and second inductors are respectively connected to a full bridge inverting circuit. The full bridge inverting circuit is connected parallelly to an energy storing capacitor. The present invention integrals conventional multiple stages invertor/convertors as a signal stage which is low cost and provides a very high transforming efficiency. The two inductors share current Loaded of the invertor, the invertor is able to provide a high power transforming performance. Switches of the full bridge inverting circuit all switch under zero voltage to reduce switching loss of the full bridge inverting circuit.

### BACKGROUND OF THE INVENTION

1. Field of Invention

The present invention relates to a full bridge oscillation resonance high power factor invertor.

2. Description of the Related Art

Power factor correction circuit has been studied and lots of programs/devices have been realized recently. One of the most commonly used circuits is two-stage hard-switching high power factor invertor that is shown as FIG. 12. In the prior art, the said “hard-switching” means that two ends of a switching circuit in the invertor kept a non-zero voltage drop during a switching process which generates a significant loss during the switching process. Conventional two-stage high power factor invertor regularly required two stages circuit. One of the two stages circuit is used for power factor correction and the other one is used for DC/AC conversion. On the other hand, heat dissipation problems of the switches are also one of the key issues to limits the performance outcome of the conventional invertor. Furthermore, an output power of the conventional invertor is limited since there has normally only one inductor is used and is very easy saturated under a high power operation, a limited average current waveform of the inductor is shown as FIG. 13.

### SUMMARY OF THE INVENTION

The primary objective of the present invention is to provide a full bridge oscillation resonance high power factor invertor to obviate and overcome short comings of the prior art and to achieve a high performance invertor. To solve the aforementioned problems or shortcomings in the prior art, a full bridge oscillation resonance high power factor invertor is provided in the present invention. The full bridge oscillation resonance high power factor invertor is connected between a power source and a Load, the invertor comprising a first inductor, a second inductor, a full bridge inverting circuit, a resonant circuit, and an energy storing capacitor, wherein the first and second inductors are respectively connected between the full bridge inverting circuit and the power source. The full bridge inverting circuit has four active switching units for being switched under a zero voltage. The energy storing capacitor and the full bridge inverting circuit are parallelly connected. The resonant circuit is connected to the Load in series and is connected to the full bridge inverting circuit.

The invertor further comprises a power rectifying circuit for filtering the current from the power source. The power rectifying circuit includes a rectifying capacitor parallelly connected to the power source and a rectifying inductor being connected in serial between the rectifying capacitor.

The advantages of the present invention are described as below.

(1). The present invention is a single-stage high power factor correction circuit having simplified circuit structure and resolves the problem of conventional inefficient two-stage circuit.

(2). The four active switching units of the full bridge inverting circuit is also provide a single state power factor correction, improves the problem of power factor, and makes the energy storing capacitor not easy to be saturated by using two inductors to share the current inputted to the converter and capable to be used in high power output circuit.

(3). The switch element of the present invention functions zero voltage switching to decrease switch loss, improve circuit efficiency, and reduce heat generated from the switch element.

(4). The circuit scheme of the present invention functions to convert the low frequency power to high frequency power and decrease the interference of high order harmonic generation; and the circuit scheme of the present invention functions to DC/AC and further adds two inductors to perform high power factor power input operation.

### BRIEF DESCRIPTION OF THE DRAWINGS

FIG. 1 is a circuit schematic diagram of a first embodiment of a full bridge oscillation resonance high power factor invertor in accordance with the present invention;

FIG. 2 is a circuit diagram of the first embodiment of the full bridge oscillation resonance high power factor invertor in accordance with the present invention;

FIG. 3 is a voltage and current waveforms of some circuit elements in accordance with the present invention;

FIG. 4 is a current waveform and composition waveform diagram of the two inductors in accordance with the present invention;

FIG. 5 a voltage or current waveform diagram of main elements of the circuit in accordance with the present invention;

FIGS. 6 and 7 are respectively an operation schematic drawing of the switches S1 and S4 of the circuit while switching ON in accordance with the present invention;

FIG. 8 is an operation schematic drawing of the switches S1 and S4 of the circuit while switching OFF in accordance with the present invention;

FIG. 9 and FIG. 10 are respectively an operation schematic drawing of the switches S2 and S3 of the circuit while switching ON in accordance with the present invention;

FIG. 11 is an operation schematic drawing of the switches S2 and S3 of the circuit while switching OFF in accordance with the present invention;

FIG. 12 is a conventional two-stage hard-switching high power factor invertor of the prior art; and

FIG. 13 is a current waveform of the prior art.

### DETAILED DESCRIPTION OF THE INVENTION

Other objectives, advantages and novel features of the invention will become more apparent from the following detailed description when taken in conjunction with the accompanying drawings.

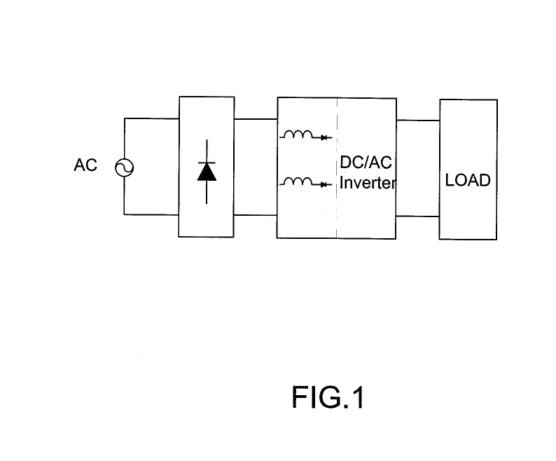

With reference to FIG. 1, a circuit schematic diagram of a first prefer embodiment of a full bridge oscillation resonance high power factor invertor in accordance with the present invention comprises a switching converter and current converter being integrally connected and having two inductors to share a input current of the invertor to solving a current saturation problem which leading to a output power limitation caused by using one inductor in the prior art. A higher power output was achieved in the present embodiment by using two inductors in the invertor.

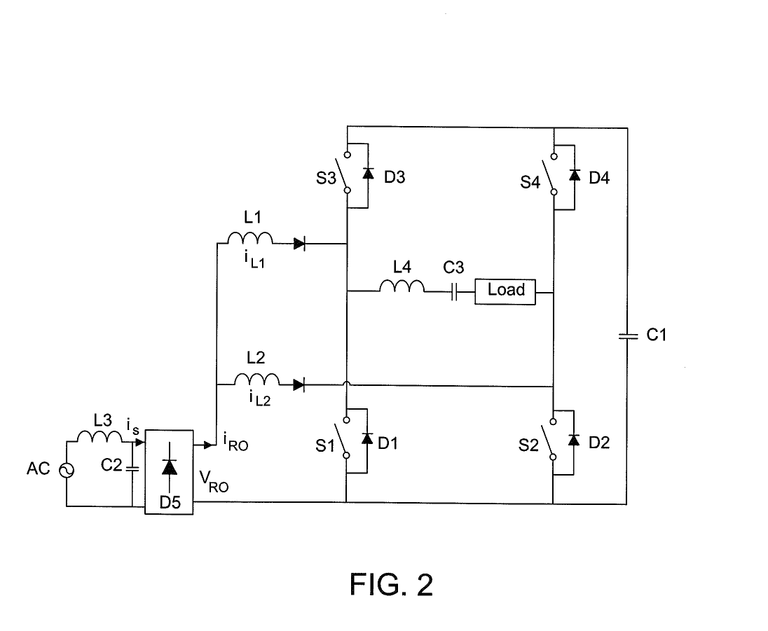

With reference to FIG. 2, the single-stage high power factor invertor in the present embodiment is connected with a power source (AC) and a Load (Load). The single-stage high power factor invertor comprises a first inductor L1, a second inductor L2, a full bridge inverting circuit S1˜S4 and D1˜D4, a resonant circuit C3 and L4, and an energy storing capacitor C1. The first inductor L1 and the second inductor L2 are respectively connected between the full bridge inverting circuit S1˜S4 and D1˜D4 and a power rectifying circuit. The full bridge inverting circuit is parallelly connected to the energy storing capacitor C1 and the energy storing capacitor C1 is used to store/discharge energy in the circuit.

The power rectifying circuit is connected in parallel between the power source and the single-stage high power factor invertor and is used for initially rectifying AC power outputted from the power source. The power rectifying circuit comprises a rectifying capacitor C2 being parallelly connected to the power source, a rectifying inductor L2 being serially connected to the power source and a bridge rectified diode D5. The bridge rectified diode D5 is used for initially rectifying an AC power from the power source (AC) for the single-stage high power factor invertor. The rectifying circuit is not limited thereto and those who skilled in the art are able to select any one of elementary rectifying circuit to perform the filtering, rectifying, and protecting the circuit.

The full bridge inverting circuit has four active switching units in full-bridge connection, and each active switching unit comprises a switch element and a diode being parallelly connected to each other. The parallelly connected diode and the switch element may be performed by a MOSFET with an embedded diode, or a FET without the embedding diode (such as BJT) connecting parallelly to an external diode. In other words, each active switching unit is equivalently comprising parallelly connected the diode and the switch element, which means the equivalent circuit of the four switch elements in full-bridge connection is including a first diode D1, a second diode D2, a third diode D3, and a fourth diode D4 connected in turn. Cathodes and anodes of the first diode D1 and the second diode D2 are respectively connected with each other. Cathodes and anodes of the third diode D3 and the fourth diode are respectively connected with each other. The first diode D1 and the third diode D3 are connected in series, and the second diode D2 and the fourth diode D4 are connected in series. Each diode D1˜D4 is parallelly connected one of the witch element S1˜S4 respectively. The first diode D1 and the switch element S1 are connected in parallel, the second diode D2 and the switch element S2 are connected in parallel, the third diode D3 and the switch element S3 are connected in parallel, and the fourth diode D4 and the switch element S4 are connected in parallel.

The first inductor L1 has a first end and a second end. The first end of the first inductor L1 is connected to a connecting node of the first diode D1 and the third diode D3. The second end of the first inductor L1 is connected to the rectified diode D5. The second inductor L2 has two ends. The two ends of the second inductor L2 are respectively connected to a connecting node of the second diode D2 and the fourth diode D4 and the rectified diode D5. Two end of the energy storing capacitor C1 are respectively connected to a connecting node of the third diode D3 and the fourth diode D4 and a node of the anodes of the first diode D1 and the second diode D2.

In the present embodiment of the present invention, the Load is serially connected to the resonant circuit L4, C3. The serially connected Load and the resonant circuit L4, C3 is connected between nodes of the first diode D1 and the third diode D3 and the second diode D2 and the fourth diode D4. The resonant circuit of the present embodiment is designed to operate in inductive Load characteristics to make each switch element S1˜S4 of the full bridge inverting circuit worked under zero-voltage switching and thus to reduce the loss during switching process.

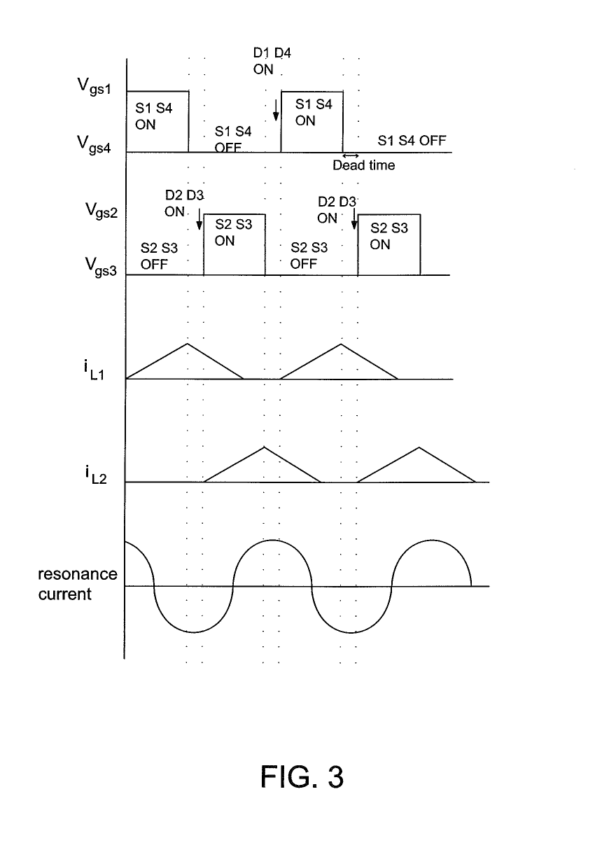

In the embodiment of the present invention, the four switch elements S1˜S4 of the full bridge inverting circuit works as a DC/AC conversion to the Load. The switch elements S1˜S4 are triggered symmetrically, that is, the switch elements S1 and S4 are switched ON synchronously and the switch elements S2 and S3 are switched ON synchronously. The switch elements S1 and S2 (or S3 and S4) are alternatively switched ON. Trigger waveforms to the switch elements S1□S4 are shown in FIG. 3. V_{gs1}, V_{gs2}, V_{gs3}, and V_{gs4} are respectively trigger signals to switch the switch elements S1˜S4 ON and OFF. The current flowed through the first inductor L1, L2 are respectively noted as i_{L1} and i_{L2}. With refer to FIG. 3, the switch elements S1 and S2 is alternatively switched ON with a dead time period (or delay time) and lead the first and second inductor L1 and L2 respectively to operate discontinuously. The dead time period is set for preventing the switch elements S1 and S4 (or switching elements S2 and S3) being switched on simultaneously. Besides, the diodes D2, D3 and diodes D1, D4 are switching ON first before switching ON the switch elements S2, S3 and switch elements S1, S4,. The switch elements S2, S3 and switch elements S1, S4 work under zero voltage switching to reduce the heat generation of the switch elements.

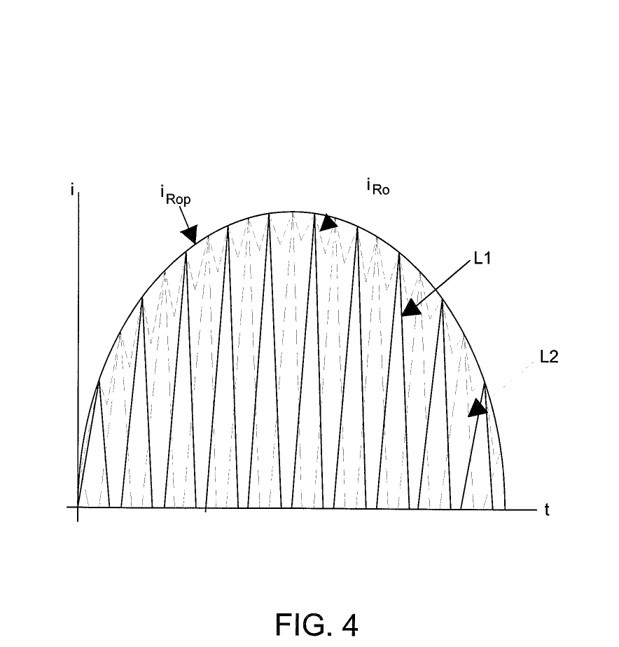

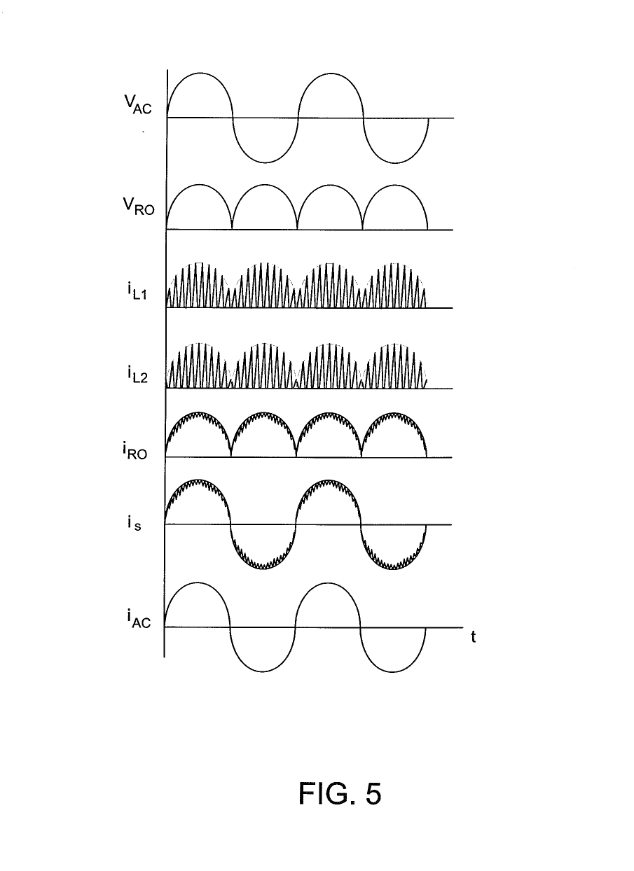

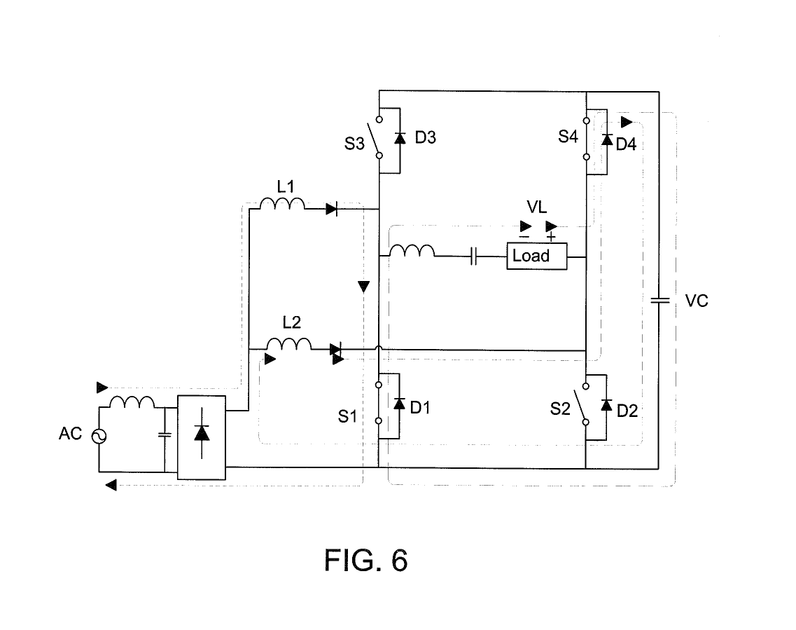

With further reference to FIGS. 4 and 5, an output current i_{RO} and an output peak current i_{ROP} of the present embodiment is achieved by the arrangement of alternatively switching ON. Since inductive currents (i_{L1} and i_{L2}) of the first inductor L1 and the second inductor L2 have a phase difference therein and are compensate in waveform to each other (the inductive current i_{L1} of the first inductor L1 is indicated by a solid line, and the inductive current i_{L2} of the second inductor L2 is indicated by a dashed line), the sum of the inductive currents, i.e. the output current i_{RO}, is then very close to a sine wave without any processing. Therefore, a high-frequency noise in the output current i_{RO} may be very easy to be removed which is reducing complexity of circuit design in the present embodiment. FIG. 5 shows the voltage or current waveforms of the key elements of the circuit. V_{AC} is referred to the voltage between two ends of the power source. V_{RO} and i_{RO} are respectively referred to the voltage and the current of the output side of the rectifying circuit. i_{S} is referred to the input current of the AC power source after being filtered. i_{AC} is referred to the input current of the AC power source before filtering. The operation sequence of the single-stage high power factor invertor in the present embodiment is illustrated as FIGS. 6 to 11 and is described as below.

(1) With reference to FIG. 6, the switch elements S1 and S4 are switched ON, the first inductor L1 is start to storing energy, the second inductor L2 may charge the energy storing capacitor C1 via the switch element S2 or the fourth diode D4 or discharge energy via the resonant circuit, and current going through Voltage VL is passed through the switch elements S4 and S1, where VL=VC.

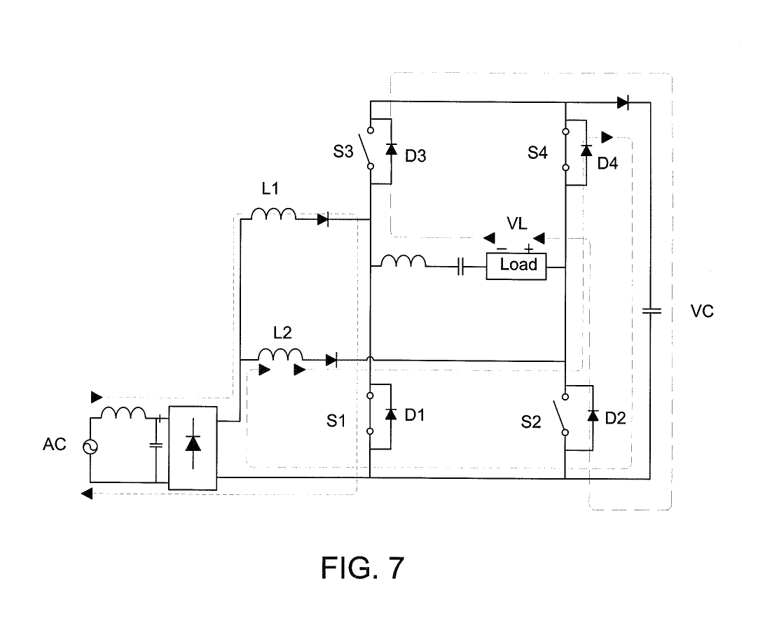

(2) With reference to FIG. 7, the switch elements S1 and S4 keep being switched ON, the first inductor L1 keeps storing energy, the inductive current of the second inductor L2 is discharging energy though the switch element S4, and the current going through voltage VL is passed through diodes D3 and D2, where VL=−VC.

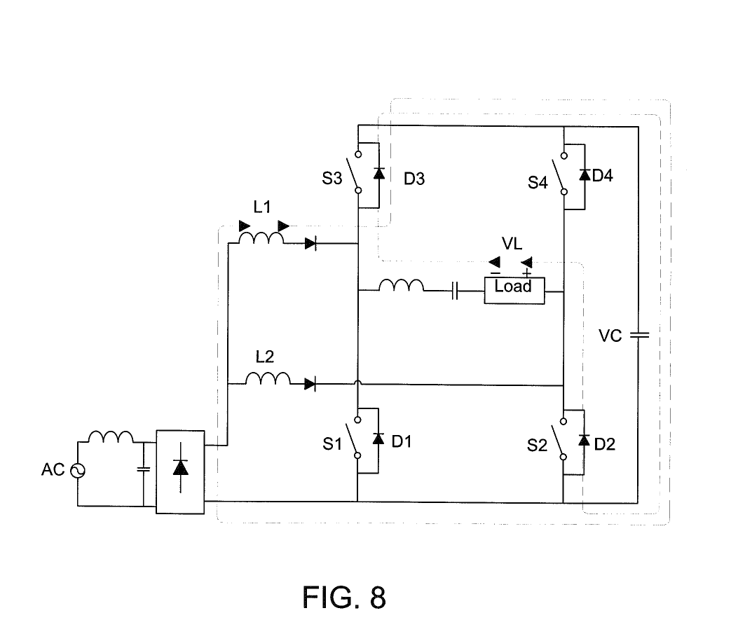

(3) With reference to FIG. 8, the switch elements S1 and S4 are switched OFF, the circuit is in a dead time, the current is discharging the energy storing capacitor C1 via the first inductor L1 and third diode D3 in turn, and the current is flowed through diodes D3 and D2 via Load VL, where VLVC.

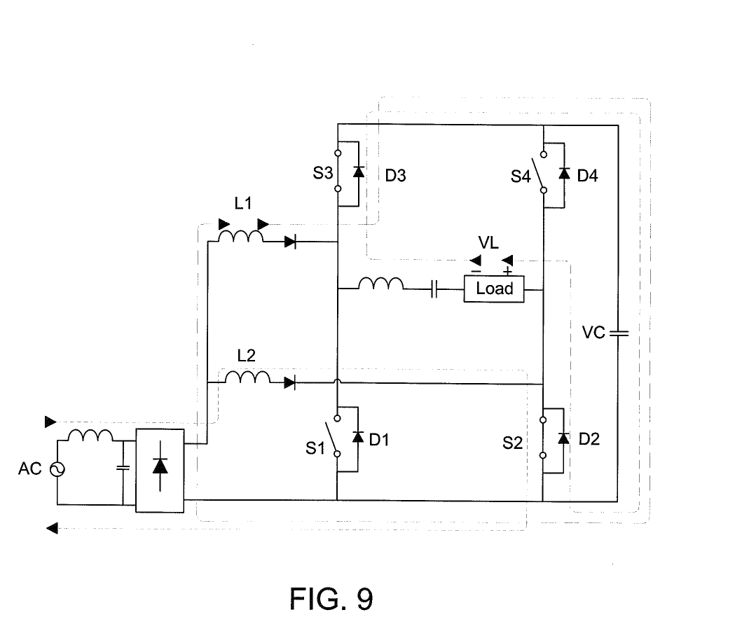

(4) With further reference to FIG. 9, the switch elements S2 and S3 are switched OFF, the second inductor L2 is storing energy, the current is charging the energy storing capacitor C1 via the first inductor L1 and switch element S3 or third diode D3 or discharging energy via connecting to the resonant circuit in series, and the current of VL is flowed through the switch elements S3 and S2, where VL=−VC.

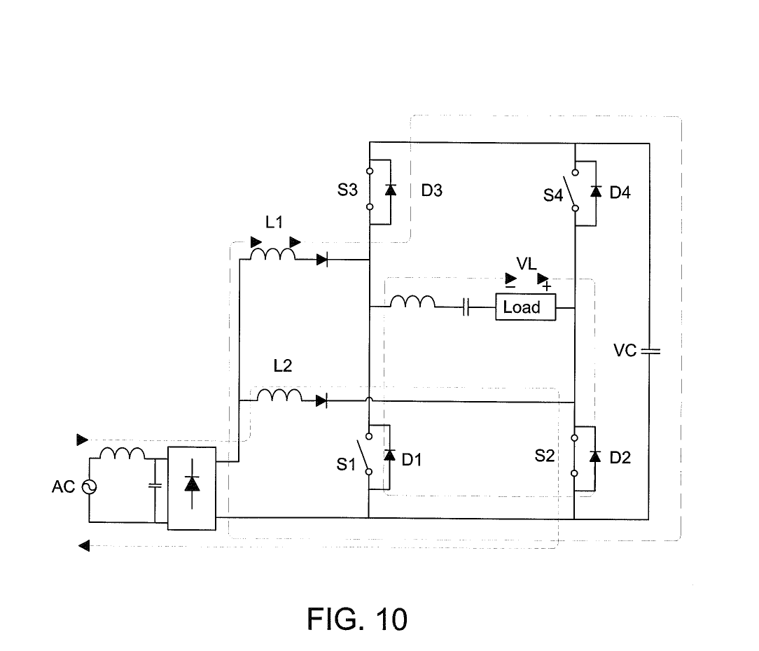

(5) With further reference to FIG. 10, the switch elements S2 and S3 keep switching ON, the second inductor L2 keeps storing energy, the current is charging the energy storing capacitor C1 via the first inductor L1 and the switch element S3, and the current of the Load VL is flowed through the switch element S2 and diode D1, where VL=VC.

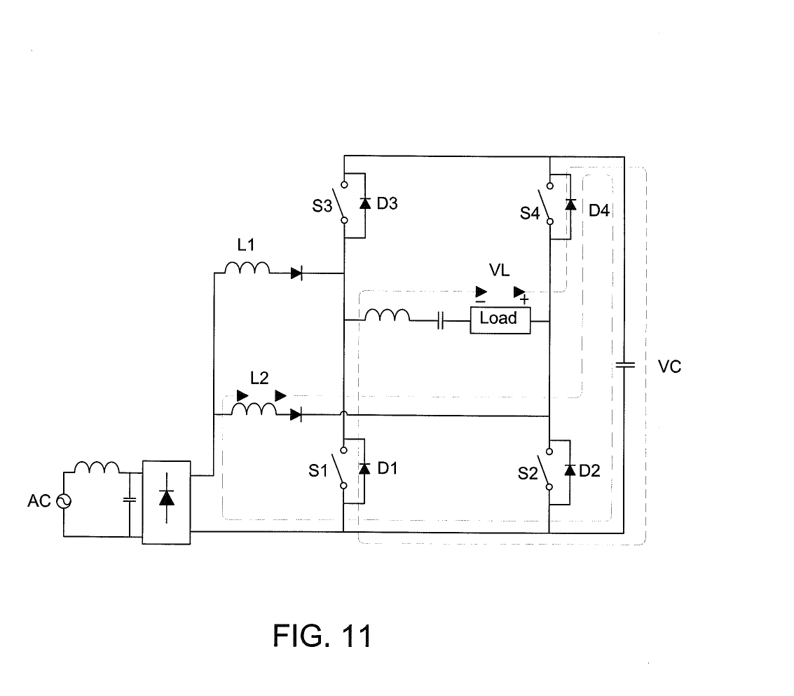

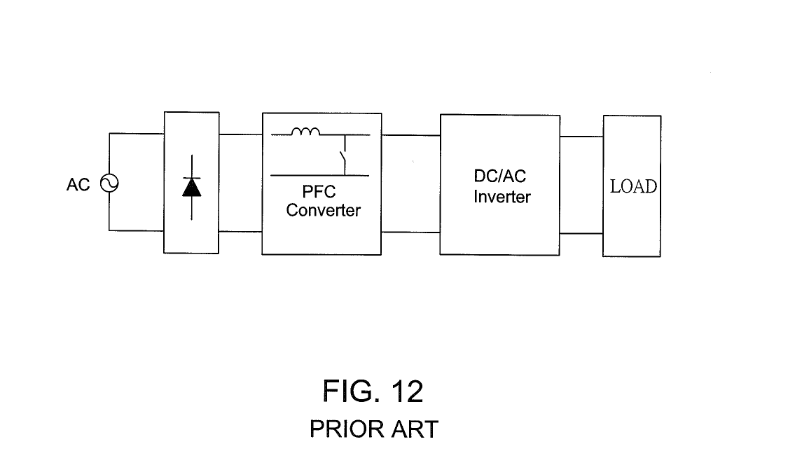

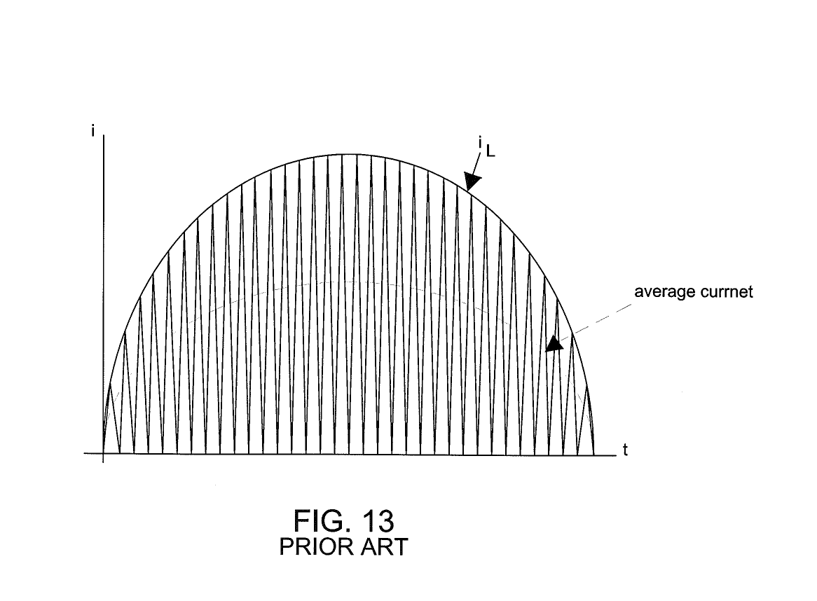

(6) With further reference to FIG. 11, the switch elements S2 and S3 are switching OFF, the second inductor L2 is charging the energy storing capacitor C1 through the diode D4, and the current of the Load VL is flowed through diodes D4 and D1, where VL=VC.

Thus, achievement of the present invention is described as below.

1. The present invention is a single-stage high power factor correction circuit having simplified structure and resolves the problem of conventional inefficient two-stage circuit.

2. Two inductors provide a very high output power and solves the saturation problem of the prior art that using signal inductor.

3. A full bridge inverting circuit working under zero voltage switching is provided. The full bridge inverting circuit is a power factor corrector and a converter simultaneously through controlling switch elements and the resonant circuit to achieve a power factor performance and a signal stage conversion.

4. The output current of the present invention before filtering process is already very close to a sine wave. Therefore, it a simplified filtering can be used in the present invention to achieve a perfect and stable output compared to prior art.

The disclosure in the foregoing description is illustrative only. Changes may be made in detail, especially in matters of shape, size and arrangement of parts within the principles of the invention to the full extent indicated by the broad general meaning of the terms in which the appended claims are expressed.

What is claimed is:

1. A full bridge oscillation resonance high power factor invertor being connected between a power source and a Load, the invertor comprising a first inductor, a second inductor, a full bridge inverting circuit, a resonant circuit and an energy storing capacitor, wherein
the first and second inductors are respectively connected between the full bridge inverting circuit and the power source;
the full bridge inverting circuit has four active switching units for being switched under zero voltage;
the energy storing capacitor and the full bridge inverting circuit are parallelly connected; and
the resonant circuit is connected to the Load in series, and is connected to the full bridge inverting circuit.

2. The full bridge oscillation resonance high power factor invertor as claimed in claim 1, wherein
a power rectifying circuit is connected among the first inductor, the second inductor and the power source;
the power rectifying circuit is bridge rectified the current outputted from the power source and outputted the current to the first and second inductors; and
the power rectifying circuit includes a rectifying capacitor connected to the power source in parallel, a rectifying inductor connected to the power source in series, and a rectifying diode connected to the rectifying capacitor in series.

3. The full bridge oscillation resonance high power factor invertor as claimed in claim 2, wherein the four active switching units of the full bridge inverting circuit are equivalent to a first diode, a second diode, a third diode, and a fourth diode connected in turn, two ends of each diode are both connected a switch element, one end of the first inductor is connected to a node of the first diode and the third diode, the other end of the first inductor is connected to the rectifying circuit, one end of the second inductor is connected to a node of the second diode and the fourth diode, the other end of the second inductor is connected to the rectifying diode, one end of the energy storing capacitor is connected to a node of the third diode and the fourth diode, and the other end of the energy storing capacitor is connected to a node of the first diode and the second diode.

4. The full bridge oscillation resonance high power factor invertor as claimed in claim 3, wherein one end of the Load is connected to a node of the first diode and the third diode, and the other end of the Load is connected to the resonant circuit in series first and then connected to a node of the second diode and the fourth diode.

5. The full bridge oscillation resonance high power factor invertor as claimed in claim 4, wherein the resonant circuit includes a resonant inductor and a resonant capacitor connected in series.
